(19) United States
(12) Patent Application Publication
(10) Pub. No.: US 2024/0055589 A1
(43) Pub. Date: Feb. 15, 2024

(54) POSITIVE ELECTRODE ACTIVE MATERIAL, POSITIVE ELECTRODE ACTIVE MATERIAL LAYER, ALL-SOLID-STATE LITHIUM ION BATTERY, MANUFACTURING METHOD OF POSITIVE ACTIVE MATERIAL, AND MANUFACTURING METHOD OF ALL-SOLID-STATE LITHIUM ION BATTERY

(71) Applicant: TOYOTA JIDOSHA KABUSHIKI KAISHA, Toyota-shi Aichi-ken (JP)

(72) Inventors: Kyosuke YOSHIDA, Susono-shi Shizuoka-ken (JP); So YUBUCHI, Sunto-gun Shizuoka-ken (JP); Jun YOSHIDA, Mishima-shi Shizuoka-ken (JP)

(73) Assignee: TOYOTA JIDOSHA KABUSHIKI KAISHA, Toyota-shi Aichi-ken (JP)

(21) Appl. No.: 18/208,477

(22) Filed: Jun. 12, 2023

(30) Foreign Application Priority Data
Aug. 15, 2022 (JP) 2022-129337

(51) Int. Cl. H01M 4/505; H01M 10/0525; H01M 4/485; H01M 4/04; H01M 10/0562

(52) U.S. Cl. CPC H01M 4/505; H01M 10/0525; H01M 4/485; H01M 4/0471; H01M 10/0562; H01M 4/0404; H01M 2004/028

(57) ABSTRACT

A positive electrode active material of the present disclosure is a positive electrode active material for an all-solid-state lithium ion secondary battery that is represented by a general formula: LiₓTi₂ₓ₋₁Mn₂₋₃ₓO (0.500<x<0.650) or a general formula: LiₓNb_{x-0.5}Mn_{1.5-2x}O (0.500<x<0.650) and that has an irregular rock salt structure. At least a part of the positive electrode active material of the present disclosure may be covered with a LiNbO₃ coating.

### CROSS-REFERENCE TO RELATED APPLICATION

This application claims priority to Japanese Patent Application No. 2022-129337 filed on Aug. 15, 2022, incorporated herein by reference in its entirety.

### BACKGROUND

### 1. Technical Field

The present disclosure relates to a positive electrode active material, a positive electrode active material layer, an all-solid-state lithium ion battery, a manufacturing method of a positive electrode active material, and a manufacturing method of an all-solid-state lithium ion battery.

### 2. Description of Related Art

WO 2017/122663 discloses a positive electrode active material for a lithium ion secondary battery that has a rock salt structure represented by the general formula: LiₓTi₂ₓ₋₁Mn₂₋₃ₓO (0.50<x<0.67) and has an average grain size of 0.5 μm.

### SUMMARY

One of the causes of the decrease in capacity due to repeated charging and discharging of the lithium ion secondary battery is deterioration of the positive electrode active material.

A main object of the present disclosure is to provide a positive electrode active material that can suppress deterioration of the positive electrode active material due to repeated charging and discharging of a lithium ion secondary battery.

The inventors have found that the above object can be achieved by the following disclosure.

### First Aspect

In a positive electrode active material for an all-solid-state lithium ion secondary battery, the positive electrode active material is represented by a general formula: LiₓTi₂ₓ₋₁Mn₂₋₃ₓO (0.500<x<0.650) or a general formula: LiₓNb_{x-0.5}Mn_{1.5-2x}O (0.500<x<0.650), and includes an irregular rock salt structure.

### Second Aspect

In the positive electrode active material according to the first aspect, at least a part of a surface is covered with a LiNbO₃ coating.

### Third Aspect

A positive electrode active material layer includes the positive electrode active material according to the first aspect or the second aspect.

### Fourth Aspect

The positive electrode active material layer according to the third aspect further includes a sulfide solid electrolyte.

### Fifth Aspect

An all-solid-state lithium ion secondary battery includes the positive electrode active material layer according to the third aspect or the fourth aspect.

### Sixth Aspect

In the all-solid-state lithium ion secondary battery according to the fifth aspect, a positive electrode current collector layer, the positive electrode active material layer, a solid electrolyte layer, a negative electrode active material layer, and a negative electrode current collector layer are provided in this order.

### Seventh Aspect

A manufacturing method of the positive electrode active material according to the first aspect or the second aspect includes: mixing Li₂CO₃, Mn₂O₃, and TiO₂ or NbO₂ in a ball mill and subjecting a mixture to firing to obtain a product; and pulverizing the product in the ball mill.

### Eighth Aspect

A manufacturing method of an all-solid-state lithium ion secondary battery includes laminating a positive electrode current collector layer, the positive electrode active material layer according to the third aspect, a solid electrolyte layer, a negative electrode active material layer, and a negative electrode current collector layer in this order.

The present disclosure can mainly provide the positive electrode active material that can suppress deterioration of the positive electrode active material due to repeated charging and discharging of the lithium ion secondary battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an all-solid-state lithium ion secondary battery 1 according to one embodiment of the present disclosure;

FIG. 2 is a graph showing an X-ray diffraction pattern of powder produced in Example 1 before and after dry ball milling;

FIG. 3 is a graph showing charge-discharge curves of the all-solid-state lithium ion secondary battery of Example 1;

FIG. 4 is a graph showing charge-discharge curves of a liquid-type lithium ion secondary battery of Comparative Example 1;

FIG. 5 is a graph showing a result of a cycle test of the all-solid-state lithium ion secondary battery of Example 1;

FIG. 6 is a graph showing a result of the cycle test of the all-solid-state lithium ion secondary battery of Example 2;

FIG. 7 is a graph showing a result of the cycle test of the all-solid-state lithium ion secondary battery of Example 3;

FIG. 8 is a graph showing a result of the cycle test of the all-solid-state lithium ion secondary battery of Example 4;

FIG. 9 is a graph showing a result of the cycle test of the liquid-type lithium ion secondary battery of Comparative Example 1;

FIG. 10 is a graph showing a result of the cycle test of the liquid-type lithium ion secondary battery of Comparative Example 2;

FIG. 11 is a graph showing a result of the cycle test of the liquid-type lithium ion secondary battery of Comparative Example 3;

FIG. 12 is a graph showing a result of the cycle test of the liquid-type lithium ion secondary battery of Comparative Example 4; and

FIG. 13 is a graph showing charge-discharge curves of the all-solid-state lithium ion secondary battery of Example 5 at the tenth cycle and the twentieth cycle.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### 1. Positive Electrode Active Material

A positive electrode active material of the present disclosure is a positive electrode active material for an all-solid-state lithium ion secondary battery. The positive electrode active material of the present disclosure is represented by the general formula: LiₓTi₂ₓ₋₁Mn₂₋₃ₓO (0.500<x<0.650) or the general formula: LiₓNb_{x-0.5}Mn_{1.5-2x}O (0.500<x<0.650) and has an irregular rock salt structure.

Here, x may be more than 0.500, 0.520 or more, 0.540 or more, 0.560 or more, or 0.580 or more, or may be 0.650 or less, 0.630 or less, 0.610 or less, or 0.590 or less.

Specifically, x may be, for example, 0.535, 0.555, 0.570, or 0.585. Examples of compounds in which x takes such a value include Li_{1.07}Ti_{0.13}Mn_{0.80}O₂, Li_{1.11}Ti_{0.22}Mn_{0.67}O₂, and Li_{1.14}Ti_{0.29}Mn_{0.57}O₂, and Li_{1.17}Ti_{0.33}Mn_{0.50}O₂.

Although not limited by the principle, the principle by which the positive electrode active material of the present disclosure can suppress deterioration due to repeated charging and discharging of a lithium ion secondary battery is considered as follows.

Some materials used as positive electrode active materials in liquid-type lithium ion secondary batteries can deteriorate due to irreversible structural changes and mechanical deterioration associated with battery use. Therefore, even when such a material is used as a positive electrode active material for an all-solid-state lithium ion secondary battery, the material may deteriorate in the same manner as when the material is used as a positive electrode active material for a liquid-type lithium ion secondary battery.

The positive electrode active material that is represented by the general formula: LiₓTi₂ₓ₋₁Mn₂₋₃ₓO (0.500<x<0.650) or the general formula: LiₓNb_{x-0.5}Mn_{1.5-2x}O (0.500<x<0.650) and that has an irregular rock salt structure can deteriorate associated with battery use when the material is used as a positive electrode active material for a liquid-type lithium ion secondary battery. However, deterioration of these positive electrode active materials is not due to irreversible structural changes and mechanical deterioration, but due to a presence of an electrolytic solution, such as elimination of O due to a reaction with the electrolytic solution and elution of Mn into the electrolytic solution. Therefore, when these positive electrode active materials are used as positive electrode active materials for the all-solid-state lithium ion secondary battery that is a lithium ion secondary battery that does not use the electrolytic solution, deterioration of the positive electrode active material due to repeated charging and discharging of the lithium ion secondary battery is suppressed.

In other words, the disclosure of the present disclosure is based on the finding that the compound that is represented by the general formula: LiₓTi₂ₓ₋₁Mn₂₋₃ₓO (0.500<x<0.650) or the general formula: LiₓNb_{x-0.5}Mn_{1.5-2x}O (0.500<x<0.650) and that has an irregular rock salt structure is suitable to be used as the positive electrode active material for the all-solid-state lithium ion battery due to the characteristics above.

In the present disclosure, the liquid-type lithium ion secondary battery is a lithium ion secondary battery using the electrolytic solution as the electrolyte. On the other hand, in the present disclosure, the all-solid-state lithium ion secondary battery is a lithium ion secondary battery in which the electrolyte is a solid electrolyte.

The positive electrode active material of the present disclosure can be coated on at least a portion of the surface with a LiNbO₃ coating.

The positive electrode active material of the present disclosure can be manufactured by a manufacturing method including, for example, mixing Li₂CO₃, Mn₂O₃ and TiO₂ or NbO₂ in a ball mill and subjecting the mixture to firing to obtain a product, and pulverizing the product in the ball mill.

More specifically, powders of Li₂CO₃, Mn₂O₃ and TiO₂ or NbO₂ may be mixed with an organic solvent such as ethanol in a wet ball mill. The wet ball mill may, for example, mix at a rotational speed of 100 rpm to 1000 rpm for five to 30 minutes, with one to five minute intervals for five to 30 cycles. Also, after wet ball milling, a cold isostatic pressing method (CIP method) may be performed before firing. The CIP method may be performed at 100 MPa to 500 MPa for one to 30 minutes.

Firing may be performed at 600° C. to 1000° C. for five to 20 hours in an air atmosphere.

The ball mill for pulverizing the product may be a dry ball mill. The dry ball mill may, for example, mix at a rotational speed of 400 rpm to 1000 rpm for five to 30 minutes, with one to five minute intervals for 20 to 60 cycles.

### 2. Positive Electrode Active Material Layer

A positive electrode active material layer of the present disclosure is a positive electrode active material layer for the all-solid-state lithium ion secondary battery. The positive electrode active material layer of the present disclosure contains the positive electrode active material of the present disclosure, and optionally a solid electrolyte, a conductive aid, and a binder.

The positive electrode active material layer of the present disclosure can be formed by, for example, depositing a positive electrode mixture slurry in which the positive electrode active material of the present disclosure, and an solid electrolyte, a conductive aid, a binder, etc., that are optional are dispersed in a solvent, such as an organic solvent, on a base material and drying the slurry. The base material may be, for example, a metal foil or the like, and may also serve as a positive electrode current collector layer.

### 2-1. Solid Electrolyte

The material of the solid electrolyte is not particularly limited, and materials that can be used as solid electrolytes used in lithium ion secondary batteries can be used. For example, the solid electrolyte may be, but not limited to, a sulfide solid electrolyte, an oxide solid electrolyte, a polymer electrolyte, or the like.

Examples of sulfide solid electrolyte include, but are not limited to, a sulfide-based amorphous solid electrolyte, a sulfide-based crystalline solid electrolyte, an aldirodite-type solid electrolyte, and the like. Specific examples of sulfide solid electrolyte include Li₂S—P₂S₅-based materials (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ, etc.; or combinations thereof, but are not limited to these.

Examples of oxide solid electrolyte include Li₇La₃Zr₂O₁₂, Li₇₋ₓLa₃Zr₁₋ₓNbₓO₁₂, Li_{7.3x}La₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ(LiPON) and the like, but are not limited to these.

The sulfide solid electrolyte and oxide solid electrolyte may be glass or crystallized glass (glass ceramic).

Examples of polymer electrolytes include polyethylene oxide (PEO), polypropylene oxide (PPO), copolymers thereof and the like, but are not limited to these.

### 2-2. Conductive Aid

The conductive aid is not particularly limited. For example, examples of the conductive aid include ketjen black (KB), vapor grown carbon fiber (VGCF), acetylene black (AB), carbon nanotube (CNT), carbon nanofiber (CNF), carbon black, coke, graphite, and carbon materials such as carbon nanofiber, metal material, and the like, but are not limited to these.

### 2-3. Binder

The binder is not particularly limited. For example, examples of the binder include materials such as polyvinylidene fluoride (PVdF), butadiene rubber (BR), polytetrafluoroethylene (PTFE) or styrene butadiene rubber (SBR), or combinations thereof, but are not limited to these.

### 3. All-Solid-State Lithium Ion Secondary Battery

The all-solid-state lithium ion secondary battery of the present disclosure include the positive electrode active material layer of the present disclosure. The all-solid-state lithium ion secondary battery of the present disclosure can include a positive electrode current collector layer, the positive electrode active material layer of the present disclosure, a solid electrolyte layer, a negative electrode active material layer, and a negative electrode current collector layer in this order.

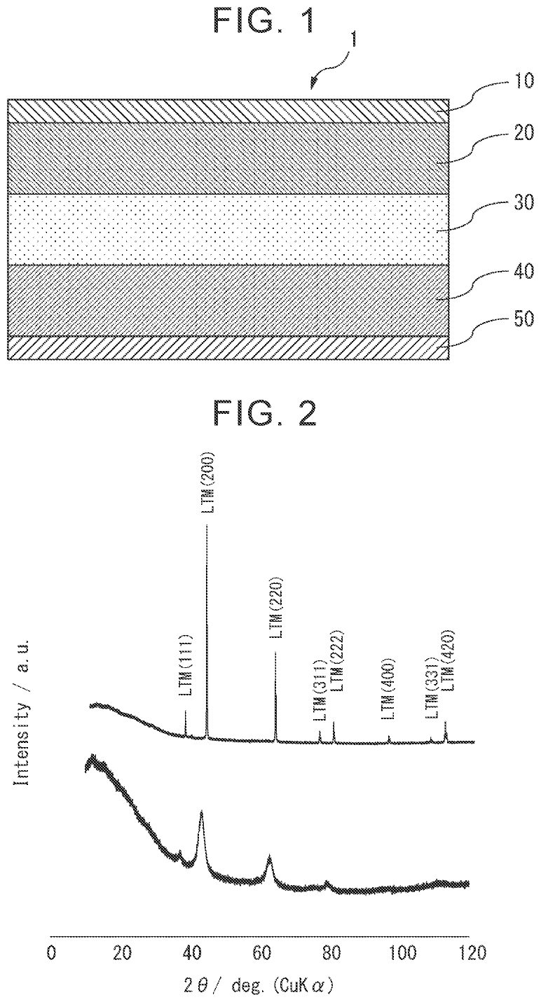

FIG. 1 is a schematic diagram of an all-solid-state lithium ion secondary battery 1 according to one embodiment of the present disclosure.

As shown in FIG. 1, the all-solid-state lithium ion secondary battery 1 according to the embodiment of the present disclosure includes a positive electrode current collector layer 10, a positive electrode active material layer 20 of the present disclosure, a solid electrolyte layer 30, a negative electrode active material layer 40, and a negative electrode current collector layer 50 in this order.

The all-solid-state lithium ion secondary battery of the present disclosure can be manufactured by a manufacturing method including, for example, laminating the positive electrode current collector layer, the positive electrode active material layer of the present disclosure, the solid electrolyte layer, the negative electrode active material layer, and the negative electrode current collector layer in this order.

The method of laminating each layer is not particularly limited. The layers may be laminated together in order of the positive electrode current collector layer, the positive electrode active material layer of the present disclosure, the solid electrolyte layer, the negative electrode active material layer, and the negative electrode current collector layer after forming each layer separately.

### 3-1. Positive Electrode Current Collector Layer

The material used for the positive electrode current collector layer is not particularly limited, and any material that can be used as a current collector for a battery can be appropriately employed.

For example, the material used for the positive electrode current collector layer may be stainless steel (SUS), aluminum, copper, nickel, iron, titanium, carbon, or the like, but is not limited to these. In some embodiments, the material of the positive electrode current collector layer is aluminum.

The shape of the positive electrode current collector layer is not particularly limited, and may be, for example, a foil shape, a plate shape, or a mesh shape. In some embodiments, shape of the positive electrode current collector layer is the foil shape.

### 3-2. Solid Electrolyte Layer

The solid electrolyte layer contains a solid electrolyte and optionally a binder or the like. Note that, for the solid electrolyte and the binder, the descriptions in “2-1. Solid Electrolyte” and “2-3. Binder” can be referred to, respectively.

### 3-3. Negative Electrode Active Material Layer

The negative electrode active material layer contains the negative electrode active material, and optionally a solid electrolyte, a conductive aid, and a binder.

The material of the negative electrode active material is not particularly limited, and may be metallic lithium or a material capable of occluding and releasing metallic ions such as lithium ions. Examples of materials capable of occluding and releasing metal ions such as lithium ions include alloy-based negative electrode active materials and carbon materials, but are not limited to these.

The alloy-based negative electrode active material is not particularly limited, and examples thereof include a Si alloy-based negative electrode active material, a Sn alloy-based negative electrode active material, and the like. The Si alloy-based negative electrode active materials include silicon, silicon oxides, silicon carbides, silicon nitrides, solid solutions thereof, and the like. In addition, the Si alloy-based negative electrode active material can contain elements other than silicon, such as Fe, Co, Sb, Bi, Pb, Ni, Cu, Zn, Ge, In, Sn, and Ti. The Sn alloy-based negative electrode active materials include tin, tin oxide, tin nitride, and solid solutions thereof. In addition, the Sn alloy-based negative electrode active material can contain elements other than tin, such as Fe, Co, Sb, Bi, Pb, Ni, Cu, Zn, Ge, In, Ti, and Si. In some embodiments, alloy-based negative electrode active material is the Si alloy-based negative electrode active material.

The carbon material is not particularly limited, and examples thereof include hard carbon, soft carbon, graphite, and the like. Note that, for the solid electrolyte, the conductive aid, and the binder, the descriptions in “2-1. Solid Electrolyte”, “2-2. Conductive Aid”, and “2-3. Binder” can be referred to, respectively.

### 3-4. Negative Electrode Current Collector Layer

The material and shape used for the negative electrode current collector layer are not particularly limited, and the materials and shapes described in the above “3-1. Positive Electrode Current Collector Layer” may be used. In some embodiments, the material of the negative electrode current collector layer is copper. In some embodiments, the shape used for the negative electrode current collector layer is the foil shape.

### EXAMPLES 1 TO 5 AND COMPARATIVE EXAMPLES 1 TO 4

### Example 1

### Synthesis of Positive Electrode Active Material

The MnCO₃ powder was subjected to firing at 700° C. for 12 hours in the atmosphere to obtain Mn₂O₃ powder.

Then, the Mn₂O₃ powder, TiO₂ powder, Li₂CO₃ powder, and ethanol were putted in a pot (45 mL) at a predetermined mass ratio, and mixed by performing wet ball milling at 300 rpm for 15 minutes and a rest time of three minutes for 17 cycles. The ZrO₂ balls used in the wet ball milling were five 10-mm balls, ten 5-mm balls, and 4 g of 1-mm balls.

The resulting mixture was subjected to a cold isostatic pressing method (CIP method) at 250 MPa for five minutes.

Next, the ship-shaped aluminum boat containing the mixture was wrapped with Cu foil and subjected to firing by heating the mixture at 900° C. for 12 hours in an argon atmosphere to obtain powder.

The resulting powder was placed in a pot (45 mL) and mixed by performing three sets of 40 cycles of dry ball milling at 600 rpm for 15 minutes with a rest time of three 10 minutes. The powder on the wall surface of the pot was scraped off for each set. The number and amount of ZrO₂ balls used for the dry ball milling was the same as for the wet ball milling above.

The resulting powder was Li_{1.14}Ti_{0.29}Mn_{0.57}O₂ powder. LiNbO₃ Coating

The resulting powder and an aqueous LiNbO₃ solution were weighed and dried while being mixed in a mortar to obtain the positive electrode active material of Example 1 that is coated with LiNbO₃. Note that, the amount of the LiNbO₃ coating with respect to the mass of the positive electrode active material including the LiNbO₃ coating was 10% by mass.

Preparation of all-Solid-State Lithium Ion Secondary Battery

The positive electrode active material of Example 1, the sulfide-based solid electrolyte, polyvinylidene fluoride (PVDF) as a binder, and vapor-grown carbon fiber (VGCF) were mixed at the mass ratio of 62.5:30.8:0.5:6.2 and dispersed and mixed in butyl butyrate to form a slurry. The slurry was dried at 165° C. to prepare a positive electrode mixture.

Li₄Ti₅O₁₂ as the negative electrode active material, a sulfide-based solid electrolyte, PVDF, and VGCF were weighed at a weight ratio of 72.1:22.7:3.5:1.7 and dispersed and mixed in butyl butyrate to form a slurry. The slurry was dried at 165° C. to prepare a negative electrode mixture.

The all-solid-state battery was prepared by integrally pressing the positive electrode mixture and the negative electrode mixture using the sulfide-based solid electrolyte was used as a separator layer.

### Examples 2 to 4

Powders of Li_{1.17}Ti_{0.33}Mn_{0.50}O₂, Li_{1.11}Ti_{0.22}Mn_{0.67}O₂, and Li_{1.07}Ti_{0.13}Mn_{0.80}O₂ were obtained in the same manner as in Example 1 except that the mass ratios of the Mn₂O₃ powder, TiO₂ powder, and Li₂CO₃ powder used were changed, respectively in this order.

Next, in the same manner as in Example 1, a LiNbO₃ coating was formed to obtain the positive electrode active material of each example.

Further, in the same manner as in Example 1, the all-solid-state lithium ion secondary battery was prepared.

### Example 5

The positive electrode active material and the all-solid-state lithium ion secondary battery of Example 5 were prepared in the same manner as in Example 1, except that the LiNbO₃ coating was not formed.

### Comparative Example 1

Using the positive electrode active material produced in Example 1, a liquid-type lithium ion secondary battery of Comparative Example 1 was prepared. Specifically, the positive electrode active material prepared in Example 1, PVDF, and acetylene black (AB) were weighed at a weight ratio of 76.5:10.0:13.5, and dispersed and mixed in N-methyl-2-pyrrolidone to form a slurry. The slurry was applied onto an Al current collector foil and vacuum dried overnight at 120° C. to prepare a positive electrode. A coin cell (CR2032) was prepared using TDDK-217 (Daikin) as the electrolytic solution and a metal Li foil as the negative electrode, and used as a liquid-type lithium ion secondary battery of Comparative Example 1.

### Comparative Exampled 2 to 4

The liquid-type lithium ion secondary batteries of Comparative Examples 2 to 4 were prepared in the same manner as in Comparative Example 1, except that the positive electrode active materials produced in Examples 2 to 4 were used in order.

### X-Ray Crystal Diffraction Test

In Example 1, the powder before the dry ball milling and the powder after the dry ball milling were measured for X-ray diffraction patterns at 2θ=0 to 120° using CuKα.

The powder before dry ball milling has the upper diffraction pattern in FIG. 2, indicating that the powder is highly crystalline Li_{1.14}Ti_{0.29}Mn_{0.57}O₂.

On the other hand, the powder after dry ball milling has the diffraction pattern shown in the lower part of FIG. 2, and broad peaks attributed to the irregular rock salt structure were observed. This indicates that the powder after dry ball milling is Li_{1.14}Ti_{0.29}Mn_{0.57}O₂ with low crystallinity.

### Charge-Discharge Test

The lithium ion battery of each example was placed in a constant temperature bath maintained at 60° C., and charging and discharging within a voltage range of 1.5 to 4.8 V and a 0.1 C rate (1 C=285 mAg-1) was performed for 20 cycles.

Also, the capacity retention rate of each example was calculated. Note that, the capacity retention rate was defined as the ratio of the discharge capacity after 20 cycles to the discharge capacity after 10 cycles.

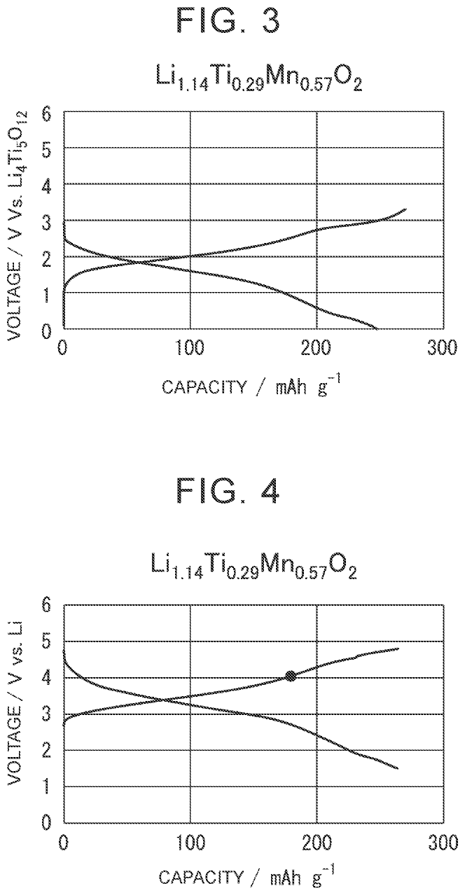

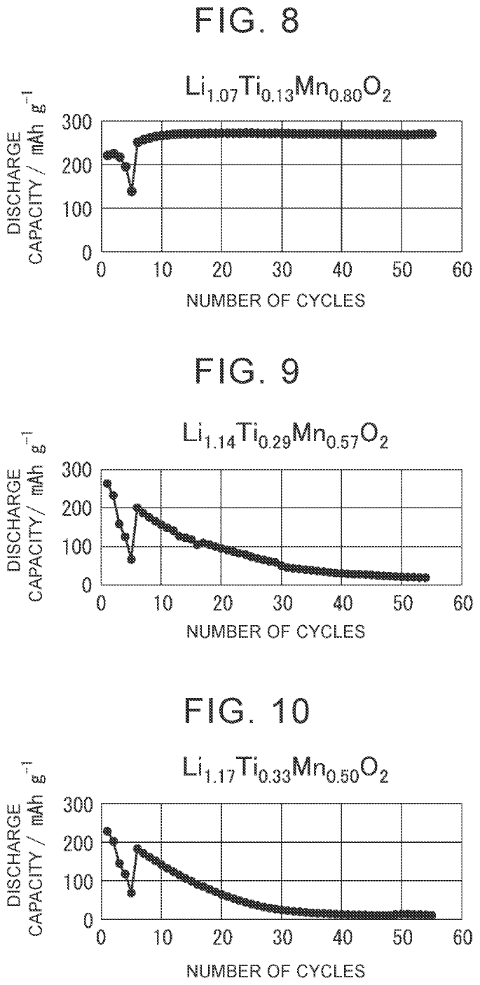

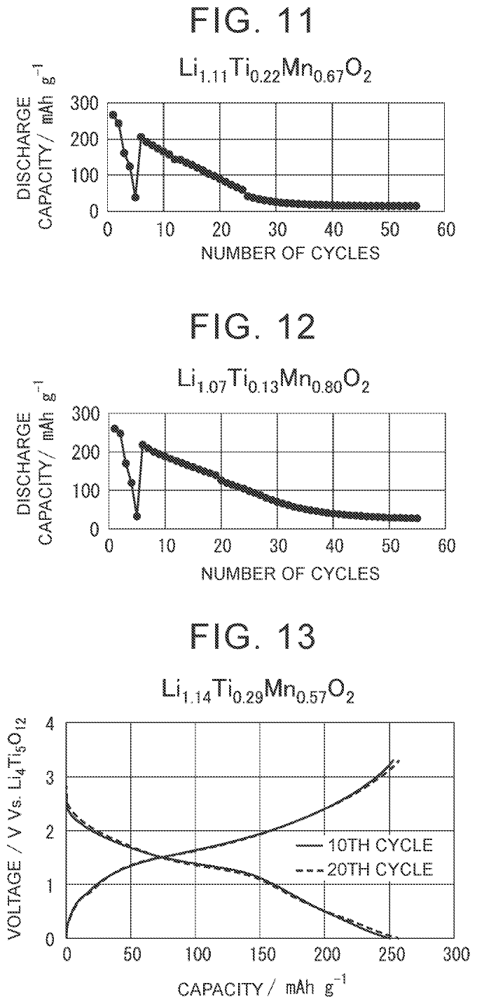

The results of charge-discharge tests of the lithium ion secondary batteries of Examples 1 to 4 and Comparative Examples 1 to 4 are shown in FIGS. 3 to 12.

FIGS. 3 and 4 are graphs showing charge-discharge curves during the initial charge-discharge of the lithium ion batteries of Example 1 and Comparative Example 1, respectively. As shown in FIGS. 3 and 4, the all-solid-state lithium ion secondary battery of Example 1 had an initial charge-discharge capacity of 247 mAh/g. On the other hand, the liquid-type lithium ion secondary battery of Comparative Example 1 had an initial charge-discharge capacity of 263 mAh/g. The difference in a charge-discharge voltage between Example 1 and Comparative Example 1 is due to the difference in the negative electrode.

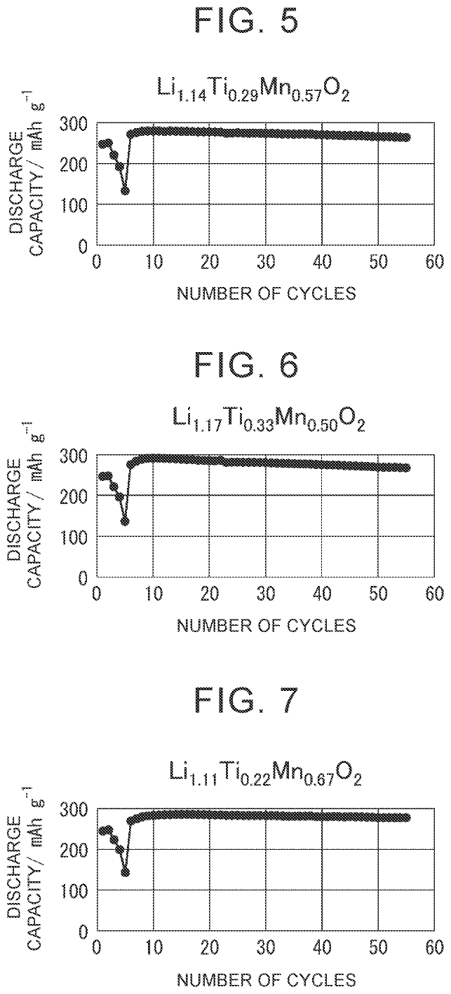

In addition, as shown in FIGS. 5 to 8, any of the all-solid-state lithium ion secondary batteries using LiₓTi₂ₓ₋₁Mn₂₋₃ₓO as a positive electrode active material had a capacity retention rate of 99% or more, and had a high capacity retention rate. On the other hand, as shown in FIGS. 9 to 12, the liquid-type lithium ion secondary battery using LiₓTi₂ₓ₋₁Mn₂₋₃ₓO as the positive electrode active material had a capacity retention rate of about 60%, and had a low capacity retention rate.

Next, Table 1 below shows the relationship between the configurations of the lithium ion secondary batteries of Example 1, Example 5, and Comparative Example 1 and the charge-discharge retention rates.

TABLE 1

| | | | | Charge-discharge Test | | | |
|---|---|---|---|---|---|---|---|
| | | | | Initial | Charge- | Charge- | |
| | | | | charge- | discharge | discharge | |
| | Configuration | | | discharge | capacity of | capacity of | Capacity |
| | Positive electrode | LINbO₃ | | capacity | tenth cycle | twentieth | retention |
| Example | active material | coating | Battery type | (mAh/g) | (mAh/g) | cycle (mAh/g) | rate (%) |
| Comparative | Li_{1.14}Ti_{0.29}Mn_{0.57}O₂ | Coated | Liquid-type | 263 | 157 | 95 | 61 |
| Example 1 | | | lithium ion | | | | |
| | | | secondary battery | | | | |
| Example 1 | Li_{1.14}Ti_{0.29}Mn_{0.57}O₂ | Coated | All-solid-state | 247 | 280 | 278 | 99 |
| | | | lithium ion | | | | |
| | | | secondary battery | | | | |
| Example 5 | Li_{1.14}Ti_{0.29}Mn_{0.57}O₂ | None | All-solid-state | 144 | 250 | 257 | 103 |
| | | | lithium ion | | | | |
| | | | secondary battery | | | | |

As shown in Table 1, Examples 1 and 5 each had a higher capacity retention rate than that of Comparative Example 1. Further, In Example 5, the charge-discharge capacity at the time of initial charge-discharge was lower than that in Example 1, but the charge-discharge capacities at the tenth cycle and the twentieth cycle became higher as 250 mAh/g and 257 mAh/g, respectively. Also in Example 5, a high capacity retention rate was obtained.

As shown in FIG. 13, in Example 5 in which the LiNbO₃ coating was not formed, there was no significant difference in charge-discharge curves between the tenth cycle and the twentieth cycle.

It is known that Nb has no valence electrons as in Ti, and has the effect of stabilizing oxidized intralattice oxygen as in Ti. Therefore, it is considered that LiₓNb_{x-0.5}Mn_{1.5-2x}O (0.50<x<0.65) shows a behavior similar to LiₓTi₂ₓ₋₁Mn₂₋₃ₓO (0.50<x<0.65). As shown in the above examples, it is considered that a high capacity retention rate can be obtained using the material as the positive electrode active material for the all-solid-state lithium ion secondary battery.

What is claimed is:

1. A positive electrode active material for an all-solid-state lithium ion secondary battery, wherein the positive electrode active material is represented by a general formula: LiₓTi₂ₓ₋₁Mn₂₋₃ₓO (0.50<x<0.65) or a general formula: LiₓNb_{x-0.5}Mn_{1.5-2x}O (0.50<x<0.65), and includes an irregular rock salt structure.

2. The positive electrode active material according to claim 1, wherein at least a part of a surface is covered with a LiNbO₃ coating.

3. A positive electrode active material layer comprising the positive electrode active material according to claim 1.

4. The positive electrode active material layer according to claim 3, further comprising a sulfide solid electrolyte.

5. An all-solid-state lithium ion secondary battery comprising the positive electrode active material layer according to claim 3.

6. The all-solid-state lithium ion secondary battery according to claim 5, wherein a positive electrode current collector layer, the positive electrode active material layer, a solid electrolyte layer, a negative electrode active material layer, and a negative electrode current collector layer are provided in this order.

7. A manufacturing method of the positive electrode active material according to claim 1, comprising:
mixing Li₂CO₃, Mn₂O₃, and TiO₂ or NbO₂ in a ball mill and subjecting a mixture to firing to obtain a product; and
pulverizing the product in the ball mill.

8. A manufacturing method of an all-solid-state lithium ion secondary battery, comprising laminating a positive electrode current collector layer, the positive electrode active material layer according to claim 3, a solid electrolyte layer, a negative electrode active material layer, and a negative electrode current collector layer in this order.
